(19) United States
(12) Patent Application Publication
(10) Pub. No.: US 2009/0123014 A1
(43) Pub. Date: May 14, 2009

(54) In-the-ear hearing device housing and the production thereof

(75) Inventors: Peter Nikles, Erlangen (DE); Erika Radick, Nurnberg (DE); Benjamin Schmidt, Nurnberg (DE); Christian Schmitt, Grossenseebach (DE); Erwin Singer, Eckental (DE); Cornelia Wiedenbrug, Spardorf (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Instruments Pte. Ltd.

(21) Appl. No.: 12/291,183

(22) Filed: Nov. 6, 2008

(30) Foreign Application Priority Data
Nov. 9, 2007 (DE) 10 2007 053 540.8

(51) Int. Cl. H04R 25/00; H04R 31/00

(52) U.S. Cl. 381/324; 381/328; 29/594

(57) ABSTRACT

A one-piece in-the-ear hearing device housing and a method for producing the in-the-ear housing are provided. The housing is mechanically separable into at least one faceplate and a housing shell. In one aspect, the hearing device housing has an interlayer between the faceplate and the housing shell. Different shrinking of the housing shell and faceplate is avoided in the production.

### CROSS REFERENCE TO RELATED APPLICATIONS

This application claims priority of German application No. 10 2007 053 540.8 DE filed Nov. 9, 2007, which is incorporated by reference herein in its entirety.

### FIELD OF INVENTION

The invention relates to an in-the-ear hearing device housing and a method for producing an in-the-ear hearing device housing.

### BACKGROUND OF INVENTION

Hearing devices exist in two embodiments; as a behind-the-ear device and as an in-the-ear device.

With in-the-ear devices, components, like for instance microphones, amplifiers and loudspeakers, are integrated in a housing shell, which is molded so as to match the auditory canal of the hearing device wearer. The front of the housing shell is completed with a faceplate.

The same applies to earmolds in behind-the-ear devices, which are similarly manufactured in accordance with an auditory canal template of the hearing device wearer.

According to the unexamined patent application DE 20 2004 001 165 U1, housing shells and faceplates are manufactured from different materials. Different materials and/or different wall thickness can thus result in different and thus troublesome shrinking occurring both during production, using injection-molding technology, as well as during assembly, using a stereolithography method. Furthermore, during the necessary polishing of the surfaces in a drum-type polishing machine, the edges of the housing shell and/or the faceplate can be damaged.

The essential method steps involved in stereolithography are described by way of example in the patent application DE 198 26 971 C2.

### SUMMARY OF INVENTION

To avoid the described disadvantages, it is thus the object of the invention to specify an improved hearing device housing.

According to the invention, the set object is achieved with the hearing device housing of the independent claims, by the hearing device housing being realized in one piece and being separable into a faceplate and a housing shell.

This is advantageous in that the housing shell and faceplate can shrink uniformly during and after production and the surface can be polished in a one-piece state such that the edges remain undamaged during the shrinking process.

In one development, the one-piece hearing device housing can comprise an interlayer, also known as a sacrificial layer, between the faceplate and housing shell, at which a simple separation is advantageously possible so that no material of the housing shell and/or the faceplate gets lost.

In one development, the interlayer is embodied such that it can be removed by means of a separator, for instance a cutting wheel.

This is advantageous in that the housing shell can be easily mechanically separated from the faceplate.

In further embodiments, the interlayer can be marked by several pins.

As a result, the position of the interlayer can be easily and reliably detected.

In a further embodiment, the interlayer can be embodied such that the faceplate can be separated from the housing shell by means of a simple external force effect, for instance by means of manual flexing or rotating, without using a separation tool.

As a result, a separation into two parts can take place easily without a tool.

In one development, the interlayer is embodied as a pillar ring or as thin-walled ring between the front surface and the housing shell.

As a result, a simple, energy-saving and precise separation of the housing shell and the faceplate is ensured.

A further object of the invention consists in specifying a method for manufacturing an improved hearing device housing.

According to the invention, the set object is achieved with the method of the independent claims.

In accordance with the invention, the method has the following two steps for producing a multi-part in-the-ear hearing device housing; assembling a one-piece hearing device housing and subsequently separating it into at least two parts, for instance a faceplate and a housing shell.

It is advantageous here that the material used shrinks uniformly, since the shrinking process is concluded prior to the separation process.

In one development, the one-piece hearing device housing is polished in a drum-type polishing machine between the assembly and separation stages.

As a result, the edges, which only appear after a separation, can avoid being damaged.

A further inventive method includes a stereolithography process, like is known for instance from the rapid prototyping.

A known and proven production method is thus used in a simple and cost-effective fashion.

### BRIEF DESCRIPTION OF THE DRAWINGS

Further details of the invention are apparent from the descriptions which follow of several exemplary embodiments with reference to schematic drawings, in which;

FIG. 1: shows a sectional view of an in-the ear hearing device,

FIG. 2: shows a one-piece hearing device housing with an interlayer,

FIG. 3: shows a one-piece hearing device housing with an interlayer marker,

FIG. 4: shows a one-piece hearing device housing with a thin-walled interlayer,

FIG. 5: shows a one-piece hearing device housing with a pillar ring as an interlayer and

FIG. 6: shows a flow chart of the production method according to the invention.

### DETAILED DESCRIPTION OF INVENTION

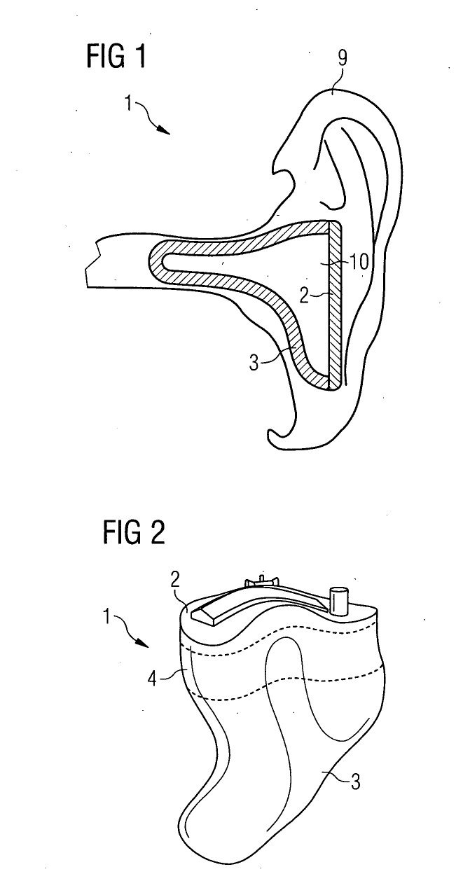

FIG. 1 shows a sectional representation of an inventive hearing device housing 1 of an in-the-ear hearing device, which is inserted in the ear 9 of the hearing device wearer. The hearing device housing 1 includes a housing shell 3 and a faceplate 2 connected thereto, which is arranged so as to open the concha of the ear 9. A hearing device electronic system (not shown in further detail) is integrated in the cavity 10 formed by the housing shell 3 and the faceplate 2. The housing shell 3 and faceplate 2 were manufactured in accordance with the invention in one piece and consist of plastic for instance.

FIG. 2 shows a spatial representation of a one-piece hearing device housing 1 of an in-the-ear hearing device. A faceplate 2 is connected to a housing shell 3 by means of an interlayer 4. Components (not described in further detail) are arranged on the faceplate 2. The hearing device housing 1 is manufactured in a stereolithography device for instance, in which the hearing device housing 1 was structured layer by layer in accordance with the casting specifications of the auditory canal of the hearing device wearer. The interlayer 4 can also consist of a material which differs from that of the faceplate 2 or the housing shell 3.

The height of the interlayer 4 is dimensioned such that this disappears when separated using a separator, for instance a cutting wheel, or when sanded following a breaking process. The interlayer 4 is thus also referred to as a sacrificial layer since the material used herefor is sacrificed for the separation process. The interlayer 4 forms a desired breaking point for breaking purposes.

The interlayer 4 is preferably offset in terms of color by comparison with the faceplate 2 and housing shell 3 for better recognition.

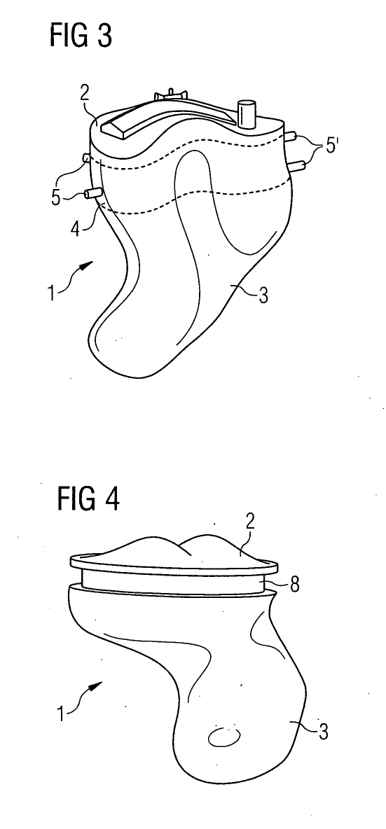

FIG. 3 shows a spatial representation of a one-piece hearing device housing 1 of an in-the-ear hearing device. A faceplate 2 is connected to a housing shell 3 by means of an interlayer 4, which is characterized by pins 5, 5′ in pairs. Color markers can also be used instead of pins 5, 5′. The pins 5, 5′ can be made from plastic. They mark the edges of the interlayer 4 to be sacrificed.

FIG. 4 shows a spatial representation of a one-piece hearing device housing 1 of an in-the-ear housing device. A faceplate 2 is connected to a housing shell 3 by an interlayer, which is embodied as a thin-walled ring 8. The thin-walled ring 8 forms a desired breaking point, at which the one-piece hearing device housing 1 can be reliably broken into two parts. This is either carried out by means of a breaking tool or manually. The wall thickness of the ring 8 is considerably smaller than the wall thickness of the housing shell 3.

The thin-walled ring 8 can either be completed as shown with the interior of the housing shell 3, so that a layer appears towards the outside or however with the outside of the housing shell 3, so that one layer appears on the interior.

FIG. 5 shows a spatial representation of a further inventive embodiment of a one-piece hearing device housing 1 of an in-the-ear hearing device. A faceplate 2 is connected to a housing shell 3 by means of an interlayer, which is embodied as a pillar ring 7. The distance between the pillars is selected here such that the one-piece hearing device housing 1 is sufficiently stable on the one hand for a polishing process and on the other hand forms a desired breaking point which can be easily broken.

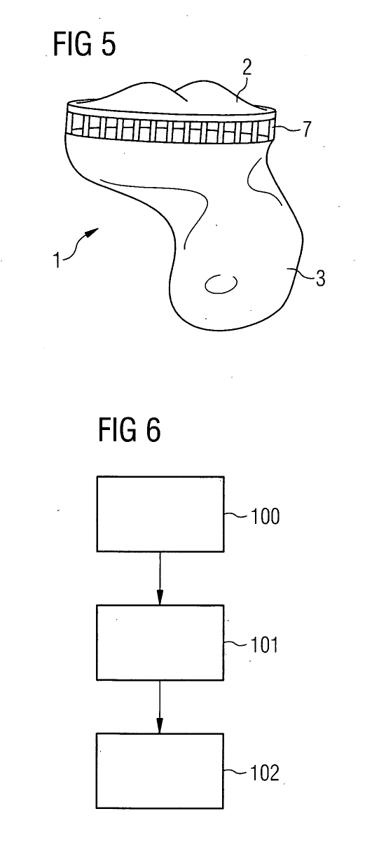

FIG. 6 shows a schematic representation of the inventive steps of the production method of a multi-part hearing device housing in the form of a flow chart. A one-piece hearing device housing is assembled with step 100, which is polished in the subsequent step 101 in a drum-type polishing machine. With step 102, the hearing device housing which is produced in one piece is separated into two parts, a faceplate and a housing shell.

The assembly 100 can preferably include a stereolithography manufacturing process.

Since the two parts are manufactured from the same material, no color differences exist between the two parts, as a result of which customer acceptance is increased.

1.-10. (canceled)

11. A one-piece in-the-ear hearing device housing, comprising:
a housing shell; and
a faceplate that is mechanically separable from the housing shell.

12. The hearing device housing as claimed in claim 11, further comprises an interlayer between the faceplate and housing shell for separation purposes.

13. The hearing device housing as claimed in claim 12, wherein the interlayer is removed by a separator during separation.

14. The hearing device housing as claimed in claim 12, wherein the interlayer includes a marking to mark the edges of the interlayer to be sacrificed.

15. The hearing device housing as claimed in claim 14, wherein the marking includes a pair of pins, a color identifier or a combination thereof.

16. The hearing device housing as claimed in claim 15, wherein the interlayer includes a marking to mark the edges of the interlayer to be sacrificed.

17. The hearing device housing as claimed in claim 13, wherein the marking includes a pair of pins, a color identifier or a combination thereof.

18. The hearing device housing as claimed in claim 12, wherein the interlayer is embodied such that the faceplate is separated from the housing shell via a mechanical force effect on the interlayer.

19. The hearing device housing as claimed in claim 12, wherein the interlayer is a pillar ring.

20. The hearing device housing as claimed in claim 12, wherein the interlayer is a thin-walled ring having a wall thickness that is less than a wall thickness of the housing shell.

21. A method for producing a multi-part in-the-ear hearing device housing, comprising:
casting a one-piece hearing device housing; and
separating the hearing device housing into at least two parts.

22. The method as claimed in claim 21, wherein the surface of the one-piece hearing device housing is polished in a drum-type polishing machine between after the casting and before the separating.

23. The method as claimed in claim 21, wherein the casting of the one-piece hearing device housing includes a stereolithography casting.

24. The method as claimed in claim 22, wherein the casting of the one-piece hearing device housing includes a stereolithography casting.

25. A method for producing a multi-part in-the-ear hearing device housing, comprising:
casting a one-piece hearing device housing using a stereolithography casting;
polishing the surface of the one-piece hearing device in a drum-type polishing machine between; and
separating the polished hearing device housing into at least two parts.

26. The method as claimed in claim 25, wherein for separation purposes the one-piece hearing device housing comprises an interlayer between the at least two parts.

27. The method as claimed in claim 26, wherein the interlayer is removed by a separator during the separating.

28. The method as claimed in claim 26, wherein the interlayer includes a marking to mark the edges of the interlayer to be sacrificed.

29. The method as claimed in claim 26, wherein the interlayer is a pillar ring.

30. The method as claimed in claim 26, wherein the interlayer is a thin-walled ring having a wall thickness that is less than a wall thickness of the housing shell.
